(19) United States
(12) Patent Application Publication
(10) Pub. No.: US 2016/0047751 A1
(43) Pub. Date: Feb. 18, 2016

(54) DIAGNOSTIC SYSTEM FOR EXHAUST SYSTEM COMPONENTS

(71) Applicant: JOHNSON MATTHEY PUBLIC LIMITED COMPANY, London (GB)

(72) Inventors: Jason PLESS, Pottstown, PA (US); Darrell Scott SAPP, Talleyville, DE (US); Penelope MARKATOU, Wayne, PA (US)

(73) Assignee: JOHNSON MATTHEY PUBLIC LIMITED COMPANY, London (GB)

(21) Appl. No.: 14/820,608

(22) Filed: Aug. 7, 2015

Related U.S. Application Data
(60) Provisional application No. 62/037,208, filed on Aug. 14, 2014.

(51) Int. Cl. G01N 21/78; B01D 53/94

(52) U.S. Cl. CPC G01N 21/78; B01D 53/9454; B01D 2255/90; G01N 2021/786; G01N 2021/7796

(57) ABSTRACT

A diagnostic system for an exhaust system of an internal combustion engine is disclosed. The diagnostic system comprises a catalyst component and a marker that undergoes a physical transition above a transition temperature of the marker. A method for determining if a catalyst component in an exhaust system for an internal combustion engine has been exposed to a deactivating temperature is also disclosed.

### CROSS-REFERENCE TO RELATED APPLICATIONS

This application claims the priority benefit of U.S. Provisional Application No. 62/037,208, filed Aug. 14, 2014, which is incorporated herein by reference.

### FIELD OF THE INVENTION

The invention relates to a diagnostic system for an exhaust system of an internal combustion engine.

### BACKGROUND OF THE INVENTION

Internal combustion engines produce exhaust gases containing a variety of pollutants, including hydrocarbons, carbon monoxide, nitrogen oxides (“NOₓ”), sulfur oxides, and particulate matter. Increasingly stringent national and regional legislation has lowered the amount of pollutants that can be emitted from such diesel or gasoline engines. Exhaust systems containing various catalyst components have been developed to attain these low emission levels.

The catalyst components operate to reduce the amount of pollutants released to atmosphere by chemically altering the exhaust gas composition produced by the engines. For example, a “three-way catalyst” (TWC) component performs three main functions: (1) oxidation of CO in the exhaust gas to produce CO₂; (2) oxidation of unburnt hydrocarbons to produce CO₂ and H₂O; and (3) reduction of NOₓ to N₂. The catalyst components typically operate at peak efficiency when the temperature of the catalyst is maintained within a certain specified range. Continued operation of the catalyst component at a temperature greater than the specified temperature range will typically lead to degradation of the catalyst material. This degradation leads to decreased performance or catalyst failure.

Because there are other possible explanations for decreased performance or failure (for example catalyst poisoning, etc.), it is important to develop a means to determine if the catalyst has been exposed to exceedingly high temperatures.

We have discovered a new diagnostic system that is capable of detecting whether a catalyst component has experienced a high aging temperature that may cause deactivation and possible failure.

### SUMMARY OF THE INVENTION

The invention is a diagnostic system for an exhaust system of an internal combustion engine. The diagnostic system comprises a catalyst component and a marker that undergoes a physical transition above its transition temperature. The invention also includes a method for determining if a catalyst component in an exhaust system for an internal combustion engine has been exposed to a deactivating temperature. The method comprises visually inspecting a marker that is located within close proximity of the catalyst component; and determining if the marker has undergone a physical transition that is indicative of exposure to a temperature above a transition temperature of the marker.

### DETAILED DESCRIPTION OF THE INVENTION

The diagnostic system of the invention comprises a catalyst component. These catalyst components are well-known in the art. The catalyst components are typically catalyst-coated substrates that comprise a catalyst coating coated on a substrate. Preferably, the catalyst component comprises a can or a shell that houses the catalyst coated-substrate.

The substrate is preferably a ceramic substrate or a metallic substrate. The ceramic substrate may be made of any suitable refractory material, e.g., alumina, silica, titania, ceria, zirconia, magnesia, zeolites, silicon nitride, silicon carbide, zirconium silicates, magnesium silicates, aluminosilicates and metallo aluminosilicates (such as cordierite and spudomene), or a mixture or mixed oxide of any two or more thereof. Cordierite, a magnesium aluminosilicate, and silicon carbide are particularly preferred.

The metallic substrate may be made of any suitable metal, and in particular heat-resistant metals and metal alloys such as titanium and stainless steel as well as ferritic alloys containing iron, nickel, chromium, and/or aluminum in addition to other trace metals.

The substrate may be a filter substrate or a flow-through substrate, depending on the application. If the substrate is a flow-through substrate, it is preferably a honeycomb monolith. The substrate is typically designed to provide a number of channels through which vehicle exhaust passes. The surface of the channels is loaded with the catalyst coating.

Three-way catalysts (TWCs) are typically used in gasoline engines under stoichiometric conditions in order to convert NOₓ to N₂, carbon monoxide to CO₂, and hydrocarbons to CO₂ and H₂O on a single device. The TWC preferably comprises a combination of two or more platinum group metals (PGMs), generally Pt/Rh, Pd/Rh or Pt/Pd/Rh. The PGMs and any catalyst promoters used, e.g. a barium-based compound, are typically supported by one or both of an oxygen storage component (OSC), e.g. a Ce—Zr mixed or composite oxide, and a high surface area inorganic oxide, e.g. alumina.

Diesel oxidation catalysts (DOCs) are designed to oxidize CO to CO₂ and gas phase hydrocarbons (HC) and an organic fraction of diesel particulates (soluble organic fraction) to CO₂ and H₂O. Typical DOC components include platinum and optionally also palladium on a high surface area inorganic oxide support, such as alumina, silica-alumina and a zeolite.

A catalyzed soot filter (CSF) is a filter substrate that is coated with a catalyst of similar composition and function to a DOC. It can also assist in the combustion of diesel particulate matter. Typical CSF catalyst components include platinum, palladium, and a high surface area inorganic oxide.

Selective catalytic reduction (SCR) catalysts are catalysts that reduce NOₓ to N₂ by reaction with nitrogen compounds (such as ammonia or urea) or hydrocarbons (lean NOₓ reduction). A typical SCR catalyst is comprised of a vanadia-titania catalyst, a vanadia-tungsta-titania catalyst, or a metal/zeolite catalyst such as iron/beta zeolite, copper/beta zeolite, copper/SSZ-13, copper/SAPO-34, Fe/ZSM-5, or copper/ZSM-5.The SCR catalyst is typically coated onto a flow-through substrate.

Selective catalytic reduction filters (SCRF) are single-substrate devices that combine the functionality of an SCR and particulate filter. They are used to reduce NOₓ and particulate emissions from internal combustion engines. An SCRF is formed when the SCR catalyst is coated onto a filter substrate.

Lean NOₓ traps (or NOₓ adsorber catalysts) are catalysts that adsorb NOₓ under lean exhaust conditions, release the adsorbed NO under rich conditions, and reduce the released NOₓ to form N₂. NOₓ traps typically include a NOₓ-storage component (e.g., Ba, Ca, Sr, Mg, K, Na, Li, Cs, La, Y, Pr, and Nd), an oxidation component (preferably Pt), and a reduction component (preferably Rh). These components are contained on one or more inorganic oxide supports.

The various catalyst systems may be added to the substrate by any known means. For example, in a three-way catalyst, a composite oxide or a PGM-containing composite oxide catalyst may be applied and bonded to the substrate as a washcoat, a porous, high surface area layer bonded to the surface of the substrate. The washcoat is typically applied to the substrate from a water-based slurry, then dried and calcined at high temperature. If only the composite oxide is washcoated on the substrate, the PGM metal may be loaded onto the dried washcoat support layer (by impregnation, ion-exchange, or the like), then dried and calcined to produce the catalyst-coated substrate.

The diagnostic system of the invention comprises a marker that undergoes a physical transition after it has been exposed to a transition temperature. The transition temperature is the temperature at which the marker undergoes a physical transition, and is preferably its melting point. Preferably, the marker is a ceramic material that comprises one or more compounds selected from boron compounds, titanium compounds, zinc compounds, sodium compounds, silicon compounds, potassium compounds, calcium compounds, aluminum compounds, chromium compounds, cobalt compounds, iron compounds, nickel compounds, copper compounds, manganese compounds, vanadium compounds, and magnesium compounds. More preferably, the ceramic material is a metal carbonate such as a nickel carbonate (such as NiCO₃), a cobalt carbonate (such as CoCO₃), a chromium carbonate (such as CrCO₃), a manganese carbonate (such as Mn(CO₃)₂ or Mn₂(CO₃)₃), or mixtures thereof.

Alternatively, the marker may comprise one or more mixed metal oxides that comprise magnesium, calcium, sodium, vanadium, molybdenum, nickel, cobalt, and lanthanum. More preferably, the mixed metal oxides are Mg₃(VO₄)₂, Ni₂(VO₄)₂, Na₃(VO₄), or mixtures thereof. The melting point of Mg₃(VO₄)₂, is 1210° C.; the melting point of Ni₂(VO₄)₂, is >900° C.; and the melting point of Na₃(VO₄) is 850° C.

Preferably, the marker comprises a series of markers. In a preferred embodiment, the marker consists of a series of stripes comprised of ceramic glazes that form colored glass at various temperatures. For example, each stripe could consist of an individual glaze that melts at a specific temperature (˜600° C., ˜815° C. and 1200° C.). Or preferably, the marker may be comprised of a series of mixed metal oxide stripes that melt at defined temperatures. For example, the stripes could consist of white, or off-white mixed metal oxides that melt and become colored above their melting temperature. Or another preference is that the markers could be composed of metal carbonates that decompose at defined temperatures and change colors.

The diagnostic system of the invention is preferably used to detect the potential thermal deterioration of a catalyst component located in the exhaust system. When used to detect the thermal deterioration of the catalyst component, the marker will preferably be located in close proximity to the catalyst component so that the marker is exposed to the same temperatures as the catalyst component. Preferably, the marker will be located within 12 inches (30.5 cm), more preferably within 6 inches (15.25 cm), and most preferably within or on the catalyst component itself.

For instance, the marker may be located on the substrate of the catalyst-coated substrate. For instance, the marker may be located within a channel of the catalyst component. More preferably, the marker is located on the can or shell of the catalyst component. By placing the marker on the outside of a catalyst component (i.e., on the skin of the can or shell, or on the outlet face of the catalyst component), it will be easily seen without having to open the can/shell of the exhaust system. In addition, the marker could be applied on or near the outlet of the catalyst component.

The diagnostic system of the invention also preferentially comprises an exhaust pipe. The exhaust pipe typically carries exhaust gas from the engine to atmosphere, by way of the catalyst component such that the exhaust gas is contacted with the catalyst component prior to exiting to atmosphere. When the diagnostic system also comprises an exhaust pipe, the marker could also be applied on the inside or outside of the exhaust pipe of the exhaust system. For instance, the marker may be located on a separate probe located within the exhaust pipe. It may also be located on a separate probe in close proximity of the catalyst component, preferably within 12 inches (30.5 cm), and more preferably within 6 inches (15.25 cm), of the catalyst component. When located in close proximity of the catalyst component, the separate probe is preferably located downstream of the catalyst component, such that the exhaust gas first contacts the catalyst component prior to contacting the separate probe.

The invention also encompasses a method for diagnostics of a catalyst component in an exhaust system for an internal combustion engine. The method comprises visually inspecting the marker(s) that is located within close proximity of the catalyst component, and determining if the marker(s) has undergone a physical transition that is indicative of exposure to a temperature above a transition temperature of the marker(s). For example, the marker may change in color from white (or off-white) to colored due to the decomposition of a mixed metal oxide or metal carbonate marker.

The following example merely illustrates the invention. Those skilled in the art will recognize many variations that are within the spirit of the invention and scope of the claims.

### EXAMPLE OF THE INVENTION

A diagnostic system may be produced by coating a three-way catalyst (TWC) component with a ceramic marker. The TWC component comprises a can (metallic housing) that houses a flow-through cordierite substrate washcoated with a TWC composition. The ceramic marker may be coated onto the can by applying a stripe of one or more mixed metal oxides (e.g., Mg₃(VO₄)₂, having a mp of 1210° C.; Ni₂(VO₄)₂, mp >900° C.; and Na₃(VO₄), mp 850° C.). The diagnostic system comprising the TWC component and ceramic marker may then be placed into an exhaust system of a test vehicle by connecting the diagnostic system to the exhaust pipe of the exhaust system.

The diagnostic system may be tested by running the test vehicle under normal operating conditions for an extended period of time. Following the test period, the ceramic markers may be visually inspected for a color change in order to determine if the TWC was exposed to high temperature deactivation temperatures. For instance, discoloration of the Na₃(VO₄) ceramic marker would indicate that the TWC was exposed to temperature above 850° C. Discoloration of the Mg₃(VO₄)₂ ceramic marker would indicate that the TWC was exposed to temperature above 1210° C.

We claim:

1. A diagnostic system for an exhaust system of an internal combustion engine, the diagnostic system comprising a catalyst component and a marker that undergoes a physical transition above a transition temperature of the marker.

2. The diagnostic system of claim 1 wherein the marker is a ceramic material comprising one or more compounds selected from the group consisting of boron compounds, titanium compounds, zinc compounds, sodium compounds, silicon compounds, potassium compounds, calcium compounds, aluminum compounds, chromium compounds, cobalt compounds, iron compounds, nickel compounds, copper compounds, manganese compounds, vanadium compounds, magnesium compounds, and mixtures thereof.

3. The diagnostic system of claim 2 wherein the ceramic material is a metal carbonate selected from the group consisting of a nickel carbonate, a cobalt carbonate, a chromium carbonate, a manganese carbonate, and mixtures thereof.

4. The diagnostic system of claim 1 wherein the marker comprises one or more mixed metal oxides comprising a metal selected from the group consisting of magnesium, calcium, sodium, vanadium, molybdenum, nickel, cobalt, lanthanum, and mixtures thereof.

5. The diagnostic system of claim 4 wherein the one or more mixed metal oxides are selected from the group consisting of Mg₃(VO₄)₂, Ni₂(VO₄)₂, Na₃(VO₄), and mixtures thereof.

6. The diagnostic system of claim 1 wherein the catalyst component is selected from the group consisting of a three-way catalyst, a diesel oxidation catalyst, a lean NOₓ trap, an SCR catalyst, a catalyzed soot filter (CSF), and an SCR coated.

7. The diagnostic system of claim 1 wherein the catalyst component comprises a catalyst coating coated on a substrate.

8. The diagnostic system of claim 7 wherein the catalyst component comprises a can or a shell that houses the catalyst coated-substrate.

9. The diagnostic system of claim 1 wherein the marker is located within 12 inches of the catalyst component.

10. The diagnostic system of claim 8 wherein the marker is located on the can or shell of the catalyst component.

11. The diagnostic system of claim 8 wherein the marker is located on the substrate of the catalyst-coated substrate.

12. The diagnostic system of claim 1 wherein the marker is located at or near an outlet of the catalyst component.

13. The diagnostic system of claim 1 further comprising an exhaust pipe wherein the marker is located on the inside or outside of the exhaust pipe.

14. The diagnostic system of claim 13 wherein the marker is located on a separate probe within the exhaust pipe.

15. A method for determining if a catalyst component in an exhaust system for an internal combustion engine has been exposed to a deactivating temperature, said method comprising:
(a) visually inspecting a marker that is located within close proximity of the catalyst component; and
(b) determining if the markers has undergone a physical transition that is indicative of exposure to a temperature above a transition temperature of the marker.
